(19) United States
(12) Patent Application Publication
(10) Pub. No.: US 2026/0200409 A1
(43) Pub. Date: Jul. 16, 2026

(54) Vehicle-Dashboard Tissue Box and Holder Device

(71) Applicant: Clarinda Masirag, Henderson, NV (US)

(72) Inventor: Clarinda Masirag, Henderson, NV (US)

(21) Appl. No.: 19/443,279

(22) Filed: Jan. 8, 2026

Related U.S. Application Data
(60) Provisional application No. 63/745,484, filed on Jan. 15, 2025.

(51) Int. Cl. B60R 7/08

(52) U.S. Cl. CPC B60R 7/084

(57) ABSTRACT

A vehicle-dashboard tissue box and holder device is provided. The device is comprised of a holder and a tissue box received by the holder, each having a generally wedge-like configuration adapted to align with the interior surface of a vehicle windshield. The rear surface of the holder may be flat, contoured, or convex, and may include fasteners for secure positioning against the windshield in one embodiment. The bottom wall of the holder may further include additional fasteners for dashboard attachment. A hinged door on the holder includes an aperture for tissue dispensing and may be secured by magnetic fasteners or other closures. The door also comprises a grabbing member to facilitate opening. The tissue box is removably insertable into the holder.

### CROSS-REFERENCE TO RELATED APPLICATION

The present application claims priority to, and the benefit of, U.S. Provisional Application No. 63/745,484, which was filed on January 15, 2025, and is incorporated herein by reference in its entirety.

### FIELD OF THE INVENTION

The present invention relates generally to the field of tissue boxes. More specifically, the present invention relates to a dashboard-mounted tissue dispenser comprising a wedge-shaped holder and a removable tissue box, both configured to align with the vehicle windshield for secure and accessible placement. Accordingly, the present disclosure makes specific reference thereto. Nonetheless, it is to be appreciated that aspects of the present invention are also equally applicable to other like applications, devices, and methods of manufacture.

### BACKGROUND

Operating a motor vehicle requires continuous attention to the road to ensure safe navigation and prevent accidents. However, during vehicle operation, drivers often experience minor hygiene-related inconveniences, such as a runny or congested nose. In such situations, drivers may attempt to locate and use tissues without pulling over, resulting in distraction and increased risk of collision. The lack of a designated, easily accessible tissue storage location within many vehicles exacerbates this issue, forcing drivers to reach into glove compartments, bags, or other areas not designed for immediate access. This creates unsafe driving conditions and contributes to decreased driver focus. Additionally, drivers may resort to unhygienic alternatives, such as using their sleeves, which is both socially undesirable and potentially unsanitary. The problem is compounded when children are passengers, as parents may divert their attention from the road to assist a child in need of a tissue. Conventional tissue boxes are typically not designed with vehicle interior contours in mind, resulting in poor fit, limited accessibility, and potential for movement during vehicle motion. There is a need for a vehicle-integrated solution that ensures hygienic convenience while minimizing driver distraction and maintaining safety.

Therefore, there exists a long-felt need in the art for a vehicle-dashboard tissue box and holder device that enables drivers to retrieve tissues without diverting attention from the road. There also exists a long-felt need in the art for a vehicle-dashboard tissue box and holder device that conforms to the vehicle windshield or dashboard for secure and stable placement. Moreover, there exists a long-felt need in the art for a vehicle-dashboard tissue box and holder device that allows convenient replacement and storage of tissue containers.

The subject matter disclosed and claimed herein, in one embodiment thereof, comprises a vehicle-dashboard tissue box and holder device. The device is comprised of a holder and a tissue box received by the holder, each having a generally wedge-like configuration adapted to align with the interior surface of a vehicle windshield. The rear surface of the holder may be flat, contoured, or convex, and may include fasteners for secure positioning against the windshield in one embodiment. The bottom wall of the holder may further include additional fasteners for dashboard attachment. A hinged door on the holder includes an aperture for tissue dispensing and may be secured by magnetic fasteners or other closures. The door also comprises a grabbing member to facilitate opening. The tissue box is removably insertable into the holder and comprises an opening with a flexible membrane having a pre-cut aperture for controlled dispensing. The device is further configurable to store other sheet-type items such as wet wipes or disposable cloths, with variations in internal volume and aperture design to accommodate different materials.

In this manner, the vehicle-dashboard tissue box and holder device of the present invention accomplishes all the foregoing objectives and provides a secure, conveniently located tissue dispenser that integrates with the shape and layout of a vehicle dashboard or windshield. More specifically, the wedge-like configuration enables stability and compatibility with vehicle interiors, while fasteners ensure the device remains fixed during operation. The inclusion of a hinged door with a dispensing aperture and a grabbing member enhances usability and reduces driver distraction. The interchangeable nature of the tissue box allows for flexible use with various hygiene products. As a result, the invention addresses the safety concerns associated with drivers reaching for tissues, supports hygienic practices, and enables parents to assist children without compromising focus on driving.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle-dashboard tissue box and holder device. The device is a dashboard-mounted tissue box holder and tissue box designed to provide accessible tissue dispensing within a vehicle, improving hygiene and user convenience while minimizing driver distraction. The device is configured to align with the sloped interior surface of a vehicle windshield, enhancing stability and visual integration with the dashboard.

The device is comprised of a holder and a tissue box, both having a generally wedge-shaped form. This configuration enables alignment with the interior surface of a windshield. The holder and tissue box include parallel top and bottom edges, a front edge generally perpendicular to said edges, and a rear edge angled at less than 90 degrees relative to the top edge. The rear surfaces of both the holder and tissue box may be linear, convex, or contoured to match the curvature of the windshield, allowing close positioning to the windshield when mounted on a dashboard. The top and bottom edges and walls may also be flat or contoured based on the dashboard’s shape.

In one configuration, the holder remains freestanding or dashboard-mounted without contacting the windshield. In another configuration, the rear surface of the holder contacts the windshield and may be comprised of at least one fastener. The bottom wall of the holder may also be secured to the dashboard using at least one fastener.

The holder is further comprised of a door that provides access to an internal space. The door is maintained in a closed position by a fastener. The door includes an aperture through which tissues are dispensed. The tissue box is further comprised of an opening with a flexible membrane that includes a pre-cut aperture to retain unused tissues while enabling smooth withdrawal. In alternative embodiments, the tissue box may store other sheet-type materials such as wet wipes, paper towels, disposable cloths, lens wipes, or disinfectant pads.

Accordingly, the vehicle-dashboard tissue box and holder device of the present invention is particularly advantageous as it provides a secure, conveniently located tissue dispenser that integrates with the shape and layout of a vehicle dashboard or windshield. More specifically, the wedge-like configuration enables stability and compatibility with vehicle interiors, while fasteners ensure the device remains fixed during operation. The inclusion of a hinged door with a dispensing aperture and a grabbing member enhances usability and reduces driver distraction. The interchangeable nature of the tissue box allows for flexible use with various hygiene products. As a result, the invention overcomes the safety concerns associated with drivers reaching for tissues, supports hygienic practices, and enables parents to assist children without compromising focus on driving.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle-dashboard tissue box and holder device of the present invention while positioned on a vehicle dashboard in accordance with the disclosed architecture; and

FIG. 2 illustrates a perspective exploded view of one potential embodiment of a vehicle-dashboard tissue box and holder device of the present invention w in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle-dashboard tissue box and holder device that enables drivers to retrieve tissues without diverting attention from the road. There also exists a long-felt need in the art for a vehicle-dashboard tissue box and holder device that conforms to the vehicle windshield or dashboard for secure and stable placement. Moreover, there exists a long-felt need in the art for a vehicle-dashboard tissue box and holder device that allows convenient replacement and storage of tissue containers.

The present invention, in one exemplary embodiment, is comprised of a vehicle-dashboard tissue box and holder device. The device is configured to provide accessible tissue dispensing within a vehicle, enhancing hygiene and user convenience while reducing driver distraction. Alignment with the sloped interior surface of a vehicle windshield contributes to improved stability and seamless visual integration with the dashboard.

The device is comprised of a holder and a tissue box, each formed in a generally wedge-shaped configuration. This shape facilitates alignment with the interior surface of the windshield. The holder and tissue box feature parallel top and bottom edges, a front edge positioned generally perpendicular to those edges, and a rear edge set at an angle of less than 90 degrees relative to the top edge. Rear surfaces may be linear, convex, or contoured to conform to the windshield curvature, enabling close positioning to the windshield when mounted on a dashboard. Additionally, top and bottom edges and walls may be either flat or contoured depending on the dashboard shape.

In one embodiment, the holder is configured for freestanding or dashboard-mounted use without windshield contact. In another embodiment, the rear surface of the holder contacts the windshield and includes at least one fastener. The bottom wall of the holder may also be secured to the dashboard through the use of one or more fasteners.

The holder includes a door that provides access to an internal compartment. A fastener maintains the door in a closed configuration. An aperture is integrated into the door to allow for tissue dispensing. The tissue box includes an opening covered by a flexible membrane with a pre-cut aperture that retains unused tissues while enabling smooth withdrawal. In alternative embodiments, the tissue box may be adapted to store other sheet-type materials such as wet wipes, paper towels, disposable cloths, lens wipes, or disinfectant pads.

As a result, the device provides a secure, conveniently positioned dispenser that aligns with the shape and design of a vehicle dashboard or windshield. The wedge-shaped configuration further enhances stability and compatibility with vehicle interiors, while fasteners ensure fixed positioning during use. The addition of a hinged door featuring a dispensing aperture and grabbing member improves ease of use and minimizes driver distraction. The interchangeable design of the box further accommodates a range of hygiene products. As a result, the invention addresses safety concerns related to accessing tissues while driving, promotes hygienic practices, and allows caregivers to assist passengers, such as children, without diverting attention from vehicle operation.

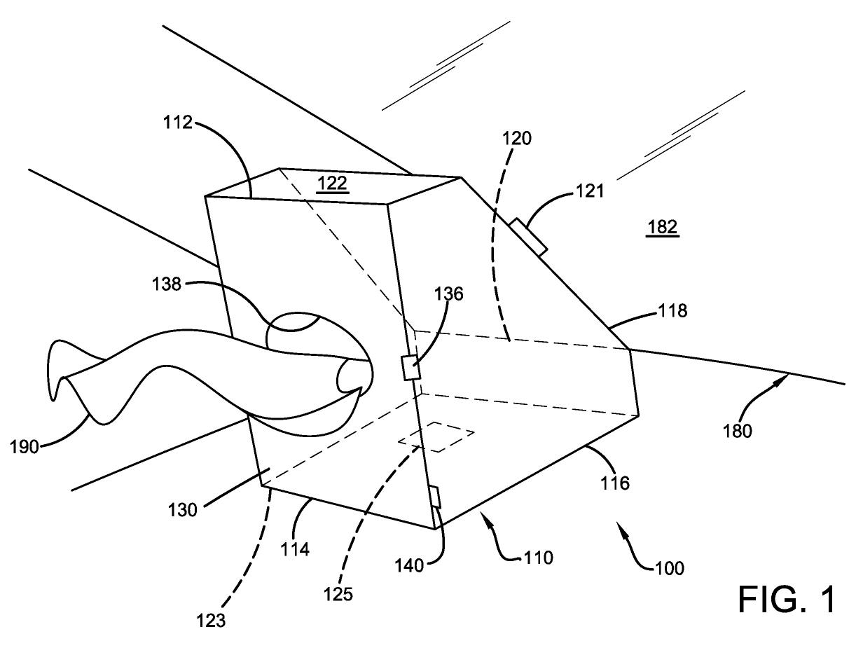

Referring initially to the drawings, FIG. 1 illustrates a perspective view of one potential embodiment of a vehicle-dashboard tissue box and holder device 100 of the present invention while positioned on a vehicle dashboard in accordance with the disclosed architecture. The device 100 is a dashboard-mounted tissue box holder and tissue box configured to provide convenient and accessible storage and dispensing of tissues or similar sheet-type materials within a vehicle. The device 100 is designed to improve hygiene and user convenience by enabling drivers or passengers to retrieve tissues without significant distraction or interruption during vehicle operation. The form factor of the device 100 may be specifically adapted to integrate with the sloped surface of a vehicle windshield, thereby enhancing usability, stability, and visual harmony with the vehicle interior.

The device 100 may be comprised of a holder 110 and a tissue box 160 removably positioned within the holder 110. Both the holder 110 and the tissue box 160 are preferably comprised of the same generally wedge-like configuration. This wedge-shaped configuration may be specifically designed to allow the holder 110 and box 160 to align with the interior surface 182 of a vehicle windshield 180, as seen in FIG. 1.

More specifically, the wedge-like configuration of both the holder 110 and the tissue box 160 may include a generally parallel top edge 112,162 and bottom edge 114,164. A side edge 116,166 may be generally perpendicular to the top edges 112,162 and bottom edges 114,164. A rear edge 118,168 may define an angle less than 90 degrees relative to the top edges 112,162, contributing to the compatibility of the device 100 with the interior surface 182. In a different embodiment, the angle of the rear edge 118,168 relative to the top edges 112,162 is greater than 90 degrees. The rear edge 118 of the holder 110 and the rear edge 168 of the tissue box 160, along with the respective rear surfaces 120,170, may be linear, convex, or contoured. Said rear surfaces 120,170 may be shaped to correspond/mirror to the interior curvature of a windshield 180, thus allowing the holder 110 and box 160 to be positioned on a vehicle dashboard close to the windshield 180 when in use (as seen in FIG. 1), unlike traditionally-shaped tissue boxes. The top edges 112,162 and bottom edges 114,164, and/or the corresponding top wall 122,172 and bottom wall 123,174 may further be flat or contoured depending on the shape of the dashboard or other mounting surface to which the device 100 is to be attached.

In one embodiment, the holder 110 does not contact the interior surface 182 of the windshield 180, allowing for a freestanding or dashboard-mounted configuration. In an alternative embodiment, the rear surface 120 of the holder 110 may contact the interior surface 182 of the windshield 180. In such a configuration, the rear surface 120 may be comprised of at least one fastener 121 (as seen in FIG. 1) such as but not limited to any combination of an adhesive layer, a non-slip rubber pad, one or more suction cups, or other pressure-sensitive attachments designed to interface securely with glass or polymer surfaces.

The bottom wall 123 of the holder 110 may further be secured to the dashboard or another vehicle interior surface using at least one fastener 125 (as seen in FIG. 1). The fastener 125 may include but is not limited to any combination of hook and loop fasteners, adhesive pads, pressure-sensitive tapes, suction cups, mechanical clips, spring-loaded clamps, or mounting brackets. In various embodiments, the fastener 125 may be located at any point along the bottom wall 123 or elsewhere on the holder 110, such as side or corner regions, depending on the specific installation requirements.

The holder 110 may further be comprised of a door 130 that permits access to an internal space 132. The door 130 may be configured to swing open via a hinge mechanism 134. The hinge mechanism 134 may include a live hinge, mechanical hinge, pivot joint, or sliding track assembly, and may be integrally formed with the holder 110 or attached during manufacturing or assembly. The door 130 may be maintained in a closed configuration via a fastener 136, as seen in FIG. 1. The fastener 136 may be comprised of but not limited to any combination of magnetic fasteners, hook and loop strips, friction-fit tabs, snap latches, rotary catches, or elastic retention bands.

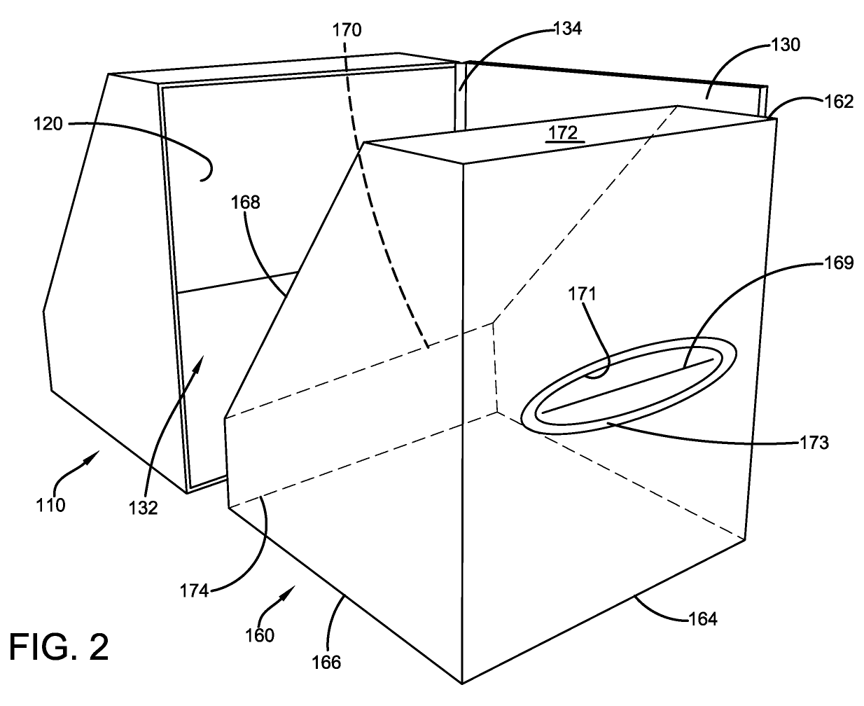

The door 130 may be comprised of an aperture 138 configured to allow tissues 190 stored within the tissue box 160 (as seen in FIG. 2) to be pulled through the door 130 for dispensing. The aperture 138 may be of a shape selected from rectangular, elliptical, slit-shaped, or other contoured forms suitable for controlled sheet-by-sheet or continuous dispensing. The aperture 138 may be dimensioned to prevent retraction of unused sheets while allowing easy retrieval. To facilitate user interaction, the door 130 may further be comprised of a grabbing member 140. The grabbing member 140 may include but is not limited to a pull tab, recessed finger groove, loop, protruding lip, toggle, or integrated handle. This feature may aid users in opening the door 130 quickly and efficiently while minimizing distraction.

The tissue box 160 is further comprised of an opening 169 through which a plurality of tissues 190 may be dispensed. The opening 169 may be comprised of a flexible membrane 173. The membrane 173 may be made from materials such as polymer film, elastomeric sheeting, or nonwoven fabric and may feature a pre-cut aperture 171 to retain unneeded tissues 190 while allowing easy withdrawal of the uppermost tissue 190 sheet.

In different embodiments, the tissue box 160 may be adapted to hold other sheet-type items such as but not limited to wet wipes, paper towels, disposable cloths, lens cleaning sheets, or disinfectant pads in lieu of tissues 190. The internal volume and aperture shape of the tissue box 160 may be varied to accommodate different material thicknesses, sheet dimensions, and dispensing characteristics.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle-dashboard tissue box and holder device” and “device” are interchangeable and refer to the vehicle-dashboard tissue box and holder device 100 of the present invention.

Notwithstanding the foregoing, the vehicle-dashboard tissue box and holder device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle-dashboard tissue box and holder device 100 as shown in the FIGS. are for illustrative purposes only, and that many other sizes and shapes of the vehicle-dashboard tissue box and holder device 100 are well within the scope of the present disclosure. Although the dimensions of the vehicle-dashboard tissue box and holder device 100 are important design parameters for user convenience, the vehicle-dashboard tissue box and holder device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle-dashboard tissue box and holder device comprising:
a holder comprised of a first top edge, a first bottom edge, a first side edge generally perpendicular to the first top edge and the first bottom edge, and a first rear edge defining an angle greater than 90 degrees relative to the first top edge;
a door comprised of an aperture, wherein the door is attached to the holder; and
a tissue box positioned within the holder, the tissue box comprising a second top edge, a second bottom edge, a second side edge generally perpendicular to the second top edge and the second bottom edge, and a second rear edge defining an angle greater than 90 degrees relative to the second top edge.

2. The vehicle-dashboard tissue box and holder device of claim 1 further comprised of a fastener that secures the door to the holder.

3. The vehicle-dashboard tissue box and holder device of claim 2, wherein the fastener is comprised of a magnetic fastener, a hook and loop strip, a friction fit tab, a snap latch, a rotary catch, or an elastic retention band.

4. The vehicle-dashboard tissue box and holder device of claim 1, wherein the door is comprised of a grabbing member comprised of a pull tab, a recessed finger groove, a loop, an integrated handle, or a protruding lip.

5. The vehicle-dashboard tissue box and holder device of claim 1, wherein the tissue box is comprised of an opening.

6. The vehicle-dashboard tissue box and holder device of claim 5, wherein the opening is comprised of a flexible membrane.

7. A vehicle-dashboard tissue box and holder device comprising:
a holder comprised of a first top edge, a first bottom edge, a first side edge generally perpendicular to the first top edge and the first bottom edge, and a first rear edge defining an angle greater than 90 degrees relative to the first top edge;
a door comprised of an aperture, wherein the door is attached to the holder;
wherein the holder is comprised of a fastener; and
a tissue box positioned within the holder, the tissue box comprising a second top edge, a second bottom edge, a second side edge generally perpendicular to the second top edge and the second bottom edge, and a second rear edge defining an angle greater than 90 degrees relative to the second top edge.

8. The vehicle-dashboard tissue box and holder device of claim 7, wherein the fastener is comprised of an adhesive layer, a non-slip rubber pad, or a suction cup.

9. The vehicle-dashboard tissue box and holder device of claim 7, wherein the fastener is positioned on a bottom wall of the holder.

10. The vehicle-dashboard tissue box and holder device of claim 7, wherein the first rear edge is comprised of a linear edge.

11. The vehicle-dashboard tissue box and holder device of claim 7, wherein the door is comprised of a grabbing member comprised of a pull tab, a recessed finger groove, a loop, an integrated handle, or a protruding lip.

12. The vehicle-dashboard tissue box and holder device of claim 7 further comprised of a second fastener that secures the door to the holder.

13. The vehicle-dashboard tissue box and holder device of claim 12, wherein the second fastener is comprised of a magnetic fastener, a hook and loop strip, a friction fit tab, a snap latch, a rotary catch, or an elastic retention band.

14. A vehicle-dashboard tissue box and holder device comprising:
a holder comprised of a first top edge, a first bottom edge, a first side edge generally perpendicular to the first top edge and the first bottom edge, and a first rear edge defining an angle greater than 90 degrees relative to the first top edge;
a door comprised of an aperture, wherein the door is attached to the holder;
wherein the door attaches to the holder via a hinge mechanism;
wherein the holder is comprised of a fastener; and
a tissue box positioned within the holder, the tissue box comprising a second top edge, a second bottom edge, a second side edge generally perpendicular to the second top edge and the second bottom edge, and a second rear edge defining an angle greater than 90 degrees relative to the second top edge.

15. The vehicle-dashboard tissue box and holder device of claim 14, wherein the first rear edge is comprised of a contoured edge.

16. The vehicle-dashboard tissue box and holder device of claim 14, wherein the hinge mechanism is comprised of a live hinge.

17. The vehicle-dashboard tissue box and holder device of claim 14, wherein the door is comprised of a grabbing member comprised of a pull tab, a recessed finger groove, a loop, an integrated handle, or a protruding lip.

18. The vehicle-dashboard tissue box and holder device of claim 14 further comprised of a second fastener that secures the door to the holder.

19. The vehicle-dashboard tissue box and holder device of claim 18, wherein the second fastener is comprised of a magnetic fastener, a hook and loop strip, a friction fit tab, a snap latch, a rotary catch, or an elastic retention band.

20. The vehicle-dashboard tissue box and holder device of claim 14, wherein the hinge mechanism is comprised of a pivot joint.
